(19) United States
(12) Patent Application Publication
(10) Pub. No.: US 2012/0216409 A1
(43) Pub. Date: Aug. 30, 2012

(54) ELECTRIC SHAVER

(75) Inventors: Hiroshi Shigeta, Osaka (JP); Kotaro Yanagi, Shiga-ken (JP); Ryo Suzuki, Shiga-ken (JP)

(73) Assignee: Panasonic Corporation, Osaka (JP)

(21) Appl. No.: 13/358,459

(22) Filed: Jan. 25, 2012

(30) Foreign Application Priority Data
Feb. 28, 2011 (JP) 2011-043047

(51) Int. Cl. B26B 19/28; B26B 19/02

(52) U.S. Cl. 30/43.91

(57) ABSTRACT

An electric shaver includes a head, outer blades located next to one another in an arrangement that extends in a front to back direction of the head, a drive source that drives a first drive element and a second drive element back and forth in different directions, and inner blades each coupled to and driven by the first drive element or the second drive element to be movable back and forth in a longitudinal direction of the outer blades, which is a widthwise direction of the head, at an inner side of the outer blades. The inner blades are coupled to the first drive element and the second drive element at a ratio of two to three.

### CROSS-REFERENCE TO RELATED APPLICATIONS

This application is based upon and claims the benefit of priority from prior Japanese Patent Application No. 2011-043047, filed on Feb. 28, 2011, the entire contents of which are incorporated herein by reference.

### BACKGROUND

The present invention relates to an electric shaver for shaving body hair such as whiskers.

Japanese Laid-Open Patent Publication No. 2001-334078 describes an example of a three-blade electric shaver. Japanese Laid-Open Patent Publication No. 2008-142276 describes an example of a four-blade electric shaver.

Such electric shavers include two drive elements, namely, a front and rear drive elements, which are driven by a drive source. In such a structure, the front and rear drive elements are driven in different directions and in opposite phases to balance vibration.

In a three-blade shaver, inner blades are coupled to the two drive elements at a ratio of one to two. However, this results in a poor weight balance. Thus, the amplitude of the drive element coupled to one inner blade is set to be greater than the amplitude of the drive element coupled to two inner blades to reduce vibration. According to this structure, rough shaving, which roughly shaves whiskers, is performed with the inner blades having the larger amplitude. Finish shaving is then performed on the remaining whiskers with the two inner blades having the smaller amplitude to avoid hurting the skin.

In a four-blade shaver, the inner blades are coupled to the two drive elements at a ratio of two to two. This results in a favorable balance.

However, in the three-blade shaver, the weight distribution of the one-to-two structure is still imbalanced, and there is a demand for further vibration reduction.

Further, in the four-blade shaver, vibration increases when the two drive elements have different amplitudes like in a three-blade shaver. Thus, it is difficult to provide the four-blade shaver with a function using different amplitudes, such as the rough and finish shaving function.

### SUMMARY

One aspect of the present invention is an electric shaver including a head, a plurality of outer blades are located next to one another in an arrangement that extends in frontward and rearward directions of the head, a drive source that drives a first drive element and a second drive element back and forth in different directions, and a plurality of inner blades each coupled to and driven by the first drive element or the second drive element to be movable back and forth in a longitudinal direction of the outer blades, which is a widthwise direction of the head, at an inner side of the outer blades. The inner blades are coupled to the first drive element and the second drive element at a ratio of two to three.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is an exploded perspective view showing an electric shaver according to one embodiment;

FIG. 2 is a cross-sectional view showing a head arranged on the electric shaver of FIG. 1;

FIG. 3A is a plan view showing the head of FIG. 2;

FIG. 3B is a schematic cross-sectional view showing part of the head of FIG. 2;

FIG. 4 is an exploded perspective view showing part of the head of FIG. 2;

FIGS. 5A to 5C are schematic cross-sectional views showing the types of outer blades arranged in the electric shaver of FIG. 1;

FIG. 6 is an exploded perspective view showing a trimmer unit arranged in the electric shaver of FIG. 1;

FIG. 7 is a lever coupling member arranged in the trimmer unit of FIG. 6; and

FIG. 8 is a schematic diagram showing how to use the electric shaver.

### DETAILED DESCRIPTION OF THE INVENTION

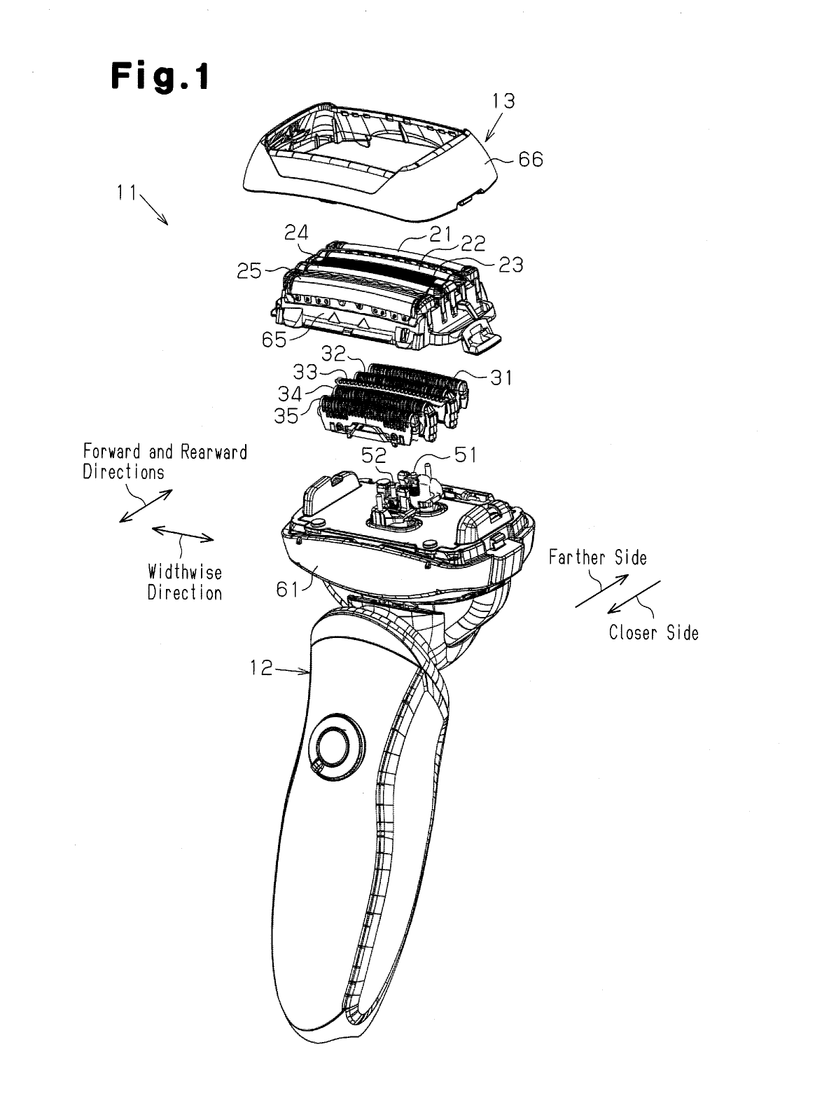

One embodiment of the present invention will now be described with reference to FIGS. 1 to 8.

As shown in FIG. 1, the electric shaver 11 includes a grip 12, which can be held by a user, and a head 13, which is arranged on an upper end of the grip 12. The grip 12 and head 13 may be formed integrally with each other.

A plurality of (five in the present embodiment) outer blades 21 to 25 are arranged on an upper end of the head 13. Body hair is guided to the inner side of the outer blades 21 to 25. The outer blades 21 to 25 are arranged next to one another in a direction parallel to the short side of the outer blades 21 to 25, that is, the frontward and rearward directions of the head 13. Inner blades 31 to 35 are arranged on the head 13 at the inner side of the outer blades 21 to 25. The inner blades 31 to 35 cooperate with the outer blades 21 to 25 to shave body hair that has been guided to the inner side of the outer blades 21 to 25. The inner blades 31 to 35 are movable back and fourth in the longitudinal direction of the outer blades 21 to 25, that is, the widthwise direction of the head 13.

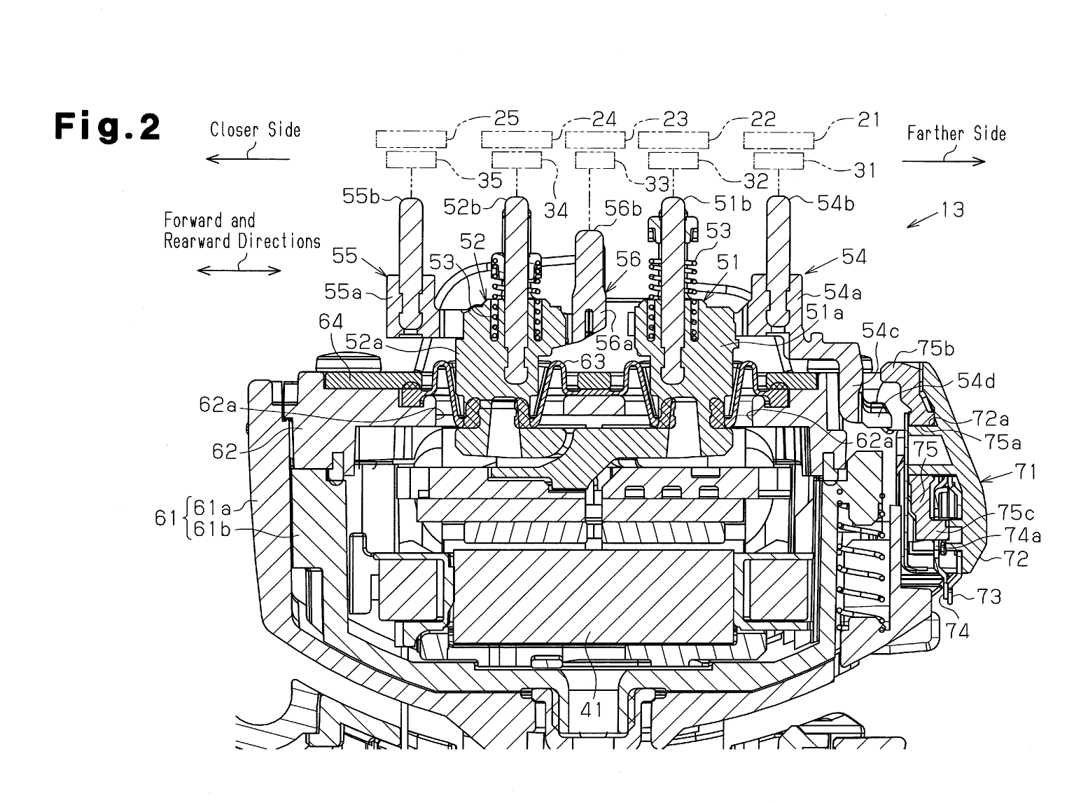

As shown in FIG. 2, the electric shaver 11 includes a linear motor 41, which is arranged in the head 13, to move a first drive element 51 and a second drive element 52 back and forth in different directions. Each of the inner blades 31 to 35 is connected to the first drive element 51 or the second drive element 52 to be moved back and fourth. The linear motor 41 is only one example of a drive source. Thus, the drive source is not limited to the linear motor 41. For example, the linear motor 41 may be replaced by a rotary motor. In such a case, a mechanism for converting rotational motion to linear reciprocation may be used to move the first and second drive elements 51 and 52 back and forth in different directions.

The inner blades 31 to 35 are coupled to the first drive element 51 and the second drive element 52 at a ratio of two to three. In the present embodiment, the first drive element 51, which is arranged at a rear side of the electric shaver 11, is coupled to the two inner blades 31 and 32. The second drive element 52, which is arranged at a front side of the electric shaver 11, is coupled to three inner blades 33 to 35. When the user holds the electric shaver 11 in a normal manner, the rear side refers to the side that is farther from the user, and the front side refers to the side that is closer to the user. An operation switch is arranged on the front side of the electric shaver 11.

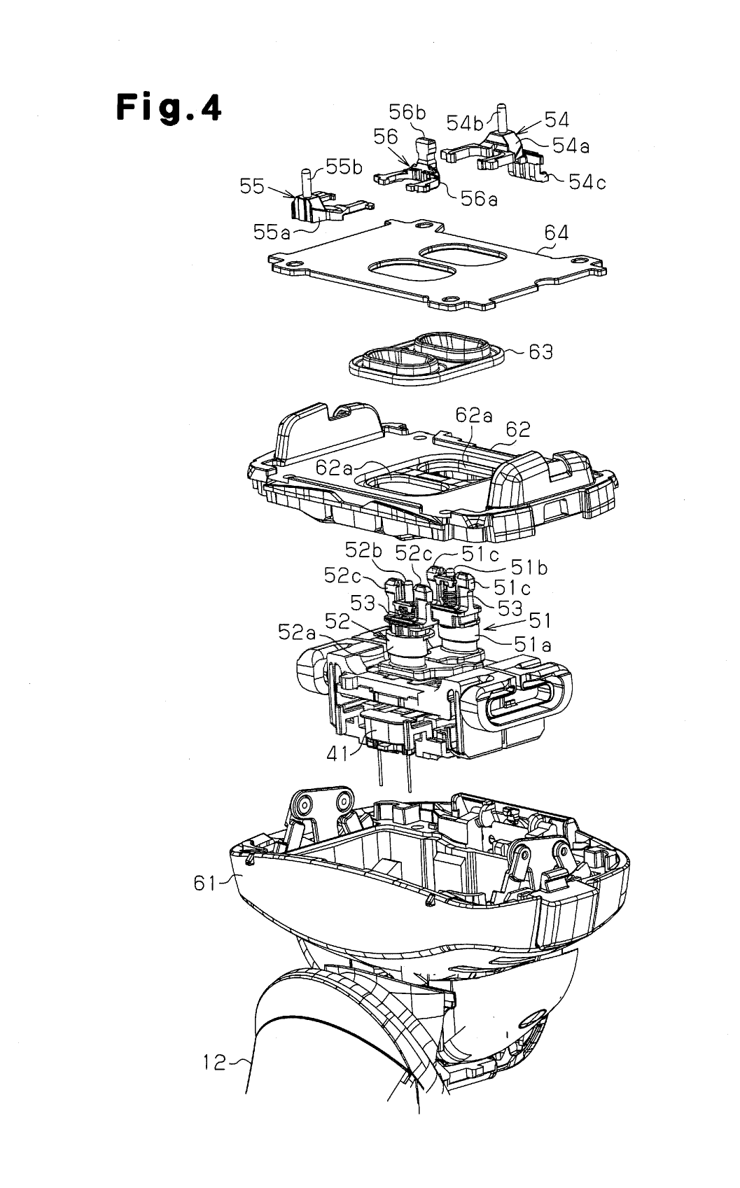

As shown in FIGS. 1 to 4, the head 13 includes a head case 61, which has an open upper portion and accommodates the linear motor 41 (refer to FIGS. 2 and 4). The head case 61 is supported to be tiltable relative to the grip 12 in frontward, rearward, leftward, and rightward directions. The head case 61 of the present embodiment includes an outer case 61a, which is waterproof and accommodate components, and an outer case 61b, which undergoes painting or printing and provides an aesthetic outer appearance. Due to this structure, the electric shaver 11 has an aesthetic outer appearance even though it has a complicated shape and function.

A rechargeable battery (not shown), which is arranged in the grip 12, supplies the linear motor 41 with drive current. This moves the first and second drive elements 51 and 52 back and forth in different directions, or in opposite phases, in the widthwise direction.

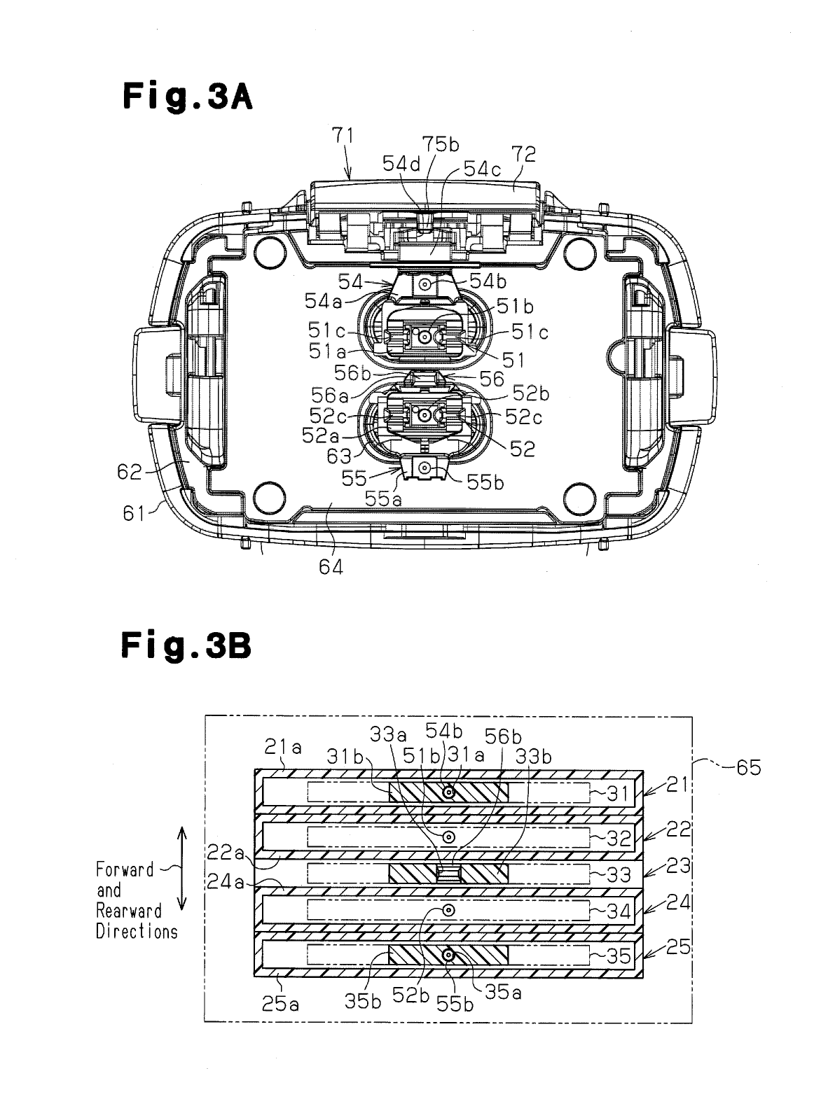

As shown in FIGS. 2 to 4, the first and second drive elements 51 and 52 include resin bases 51a and 52a and metal pins 51b and 52b, respectively. The bases 51a and 52a project upward from the open upper portion of the head case 61. The pins 51b and 52b include lower parts, which are embedded in the bases 51a and 52a, upper parts, which project upward from the bases 51a and 52a. As shown in FIGS. 3A and 4, resin support 51c is arranged on the base 51a at opposite sides of the pin 51b, and resin support 52c is arranged on the base 52a at opposite sides of the pin 52b. The supports 51c and 52c are arranged parallel to the pins 51b and 52b and formed integrally with the bases 51a and 52a, respectively.

As shown in FIGS. 2 and 4, a resin cover 62 covers the opening of the head case 61 in a waterproof manner. Through holes 62a extend through the resin cover 62 at portions corresponding to the bases 51a and 52a. A rubber seal 63 is arranged between the walls of the through holes 62a and the bases 51a and 52a to prevent liquid from entering the head case 61, while permitting the bases 51a and 52a to be driven back and fourth. The periphery of the rubber seal 63 is supported by the resin cover 62. The rubber seal 63 is fixed between the resin cover 62 and a metal cover plate 64. The metal cover plate 64 is fastened to the head case 61 together with the resin cover 62 by screws (not shown), which are inserted through the resin cover 62 and engaged with the head case 61.

The inner blade 32 is coupled to the first drive element 51, and the inner blade 34 is coupled to the second drive element 52. As shown in FIGS. 2 and 4, in the present embodiment, springs 53 are fitted to the pins 51b and 52b to urge the inner blades 32 and 34 upward while allowing the inner blades 32 and 34 to be tilted. The inner blades 32 and 34 are driven back and forth integrally with the corresponding supports 51c and 52c, pins 51b and 52b, and springs 53.

Further, as shown in FIGS. 2 to 4, a first drive piece 54 is fixed to the first drive element 51, and a second drive piece 55 is fixed to the second drive element 52. The outermost inner blades 31 and 35, which are located at the rearmost and frontmost positions, are coupled to the first and second drive pieces 54 and 55. In the present embodiment, the first and second drive pieces 54 and 55 respectively include resin fastening portions 54a and 55a fixed to the first and second drive elements 51 and 52. As shown in FIG. 4, each of the fastening portions 54a and 55a includes two arms. The fastening portions 54a and 55a are respectively fitted to the first and second drive elements 51 and 52 so as to hold the bases 51a and 52a with the arms. The first drive piece 54 includes a metal pin 54b having a lower portion embedded in the fastening portion 54a and an upper portion projecting upward from the fastening portion 54a. The second drive piece 55 includes a metal pin 55b having a lower portion embedded in the fastening portion 55a and an upper portion projecting upward from the fastening portion 55a. The outermost inner blades 31 and 35 are coupled to the metal pins 54b and 55b, respectively.

As shown in FIGS. 2 to 4, a middle drive piece 56, which is coupled to the middle inner blade 33, is fixed to the second drive element 52. The middle drive piece 56 includes a resin fastening portion 56a, which is fixed to the second drive element 52, and a resin support 56b, which is formed integrally with the fastening portion 56a and coupled to the middle inner blade 33. As shown in FIG. 4, the fastening portion 56a includes two arms. The fastening portion 56a is fitted to the second drive element 52 so as to hold the base 52a with the arms. The support 56b is arranged between the first and second drive elements 51 and 52 (pins 51b and 52b) and project upward parallel to the pins 51b and 52b. As shown in FIGS. 3A and 3B, the support 56b is tetragonal when viewed from above and includes sides extending in the frontward and rearward directions and the widthwise direction.

As schematically shown in FIG. 3B, the outermost inner blades 31 and 35 and the middle inner blade 33 are held by a holding frame 65 together with the outer blades 21 to 25 before being coupled to the pins 54b and 55b and the support 56b, respectively. The holding frame 65 may serve as a blade holding unit that holds the inner blades 31, 33, and 35 and the outer blades 21 to 25. In the present embodiment, the outer blades 21 to 25 are immovable relative to the holding frame 65 in the frontward, rearward, and widthwise directions and movable in the upward and downward directions. Further, the outer blades 21 to 25 are tiltable and urged upward by springs (not shown) relative to the holding frame 65. As schematically shown in FIG. 3B, the outer blades 21, 22, 24, and 25 respectively include frame portions 21a, 22a, 24a, and 25a, which are rectangular when viewed from above. The outermost inner blades 31 and 35 are respectively arranged in the frame portions 21a and 25a and movable in the widthwise direction relative to the frame portions 21a and 25a. Further, the inner blades 31 and 35 are tiltable and urged upward by springs (not shown). The middle inner blade 33 is arranged between the frame portions 22a and 24a and movable in the widthwise direction. Further, the inner blade 33 is tiltable and urged upward by a spring (not shown).

Referring to FIG. 1, the blade holding unit, or the holding frame 65 is fitted into a top frame 66. The top frame 66 is coupled to the head case 61. When the top frame 66 is coupled to the head case 61, the outermost inner blades 31 and 35 and the middle inner blade 33 are respectively coupled to the pins 54b and 55b and the support 56b. In the present embodiment, as schematically shown in

FIG. 3B, the outermost inner blades 31 and 35, respectively, include resin portions 31b and 35b. The resin portions 31b and 35b have coupling holes 31a and 35a, which serve as pin coupling portions and which extend through the resin portions 31b and 35b, respectively. The middle inner blade 33 includes a resin portion 33b. The resin portion 33b has a coupling groove 33a, which serves as a resin coupling portion (fitting portion) and extends through the resin portion 33b. The coupling holes 31a and 35a are circular and have slightly larger diameters than the corresponding pins 54b and 55b, which are cylindrical. The coupling groove 33a is shaped to couple the support 56b so that the support 56b is immovable relative to the inner blade 33 in the widthwise direction but movable slightly in the frontward and rearward directions. In the present embodiment, the coupling groove 33a is an opening having dimensions that are slightly greater than the support 56b in the frontward and rearward directions. When the pins 54b and 55b are fitted to the corresponding coupling holes 31a and 35a and the support 56b is fitted to the coupling groove 33a. In this manner, the pins 54b and 55b and support 56b are respectively coupled to the corresponding inner blades 31, 35, and 33.

The types of the outer blades 21 to 25 and inner blades 31 to 35 in the present embodiment will now be described.

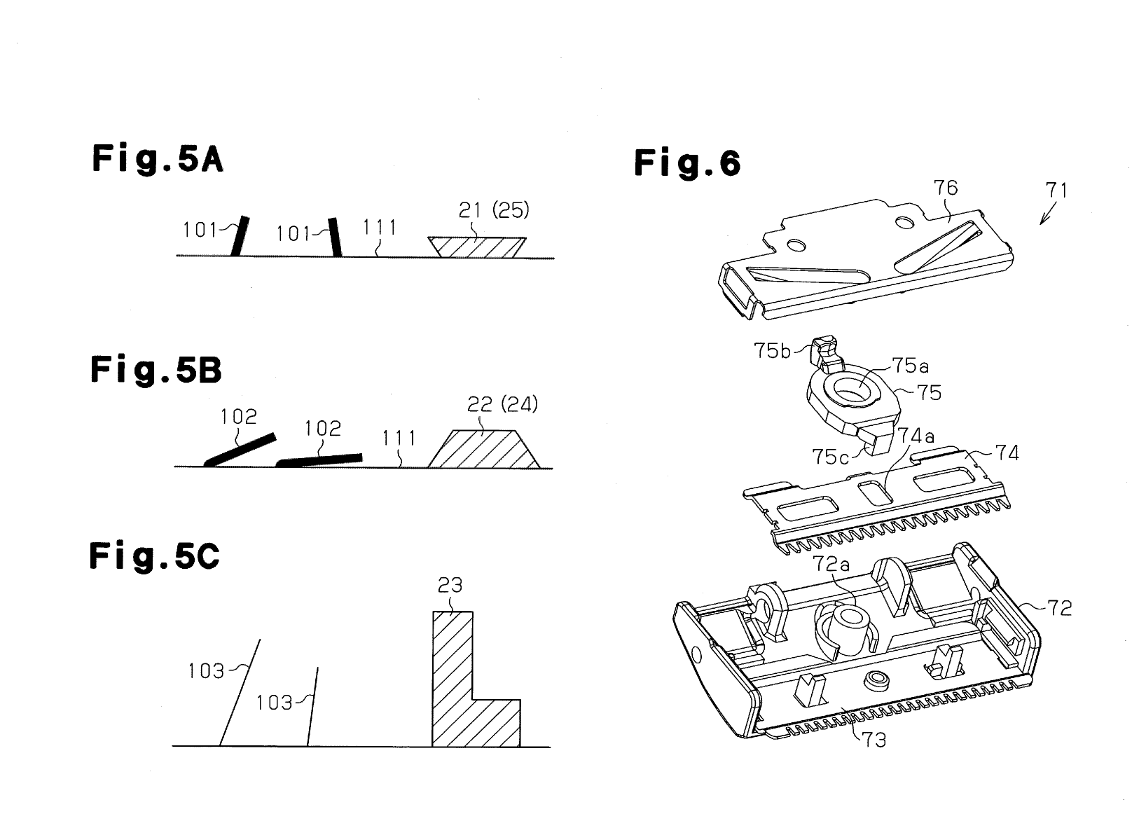

As schematically shown in FIG. 5A, the outermost outer blades 21 and 25 and the outermost inner blades 31 and 35 (not shown in FIG. 5A) are mainly used to shave short and upright whiskers 101. Preferably, each of the outer blades 21 and 25 is meshed and has a generally trapezoidal cross-sectional. The short side of the trapezoidal cross-section serves as an outer side that comes into contact with the skin 111.

As schematically shown in FIG. 5B, the outer blades 22 and 24 and the inner blades 32 and 34 (not shown in FIG. 5B), which are located next to and inward from the outermost outer blades 21 and 25 and inner blades 31 and 35, are mainly used to shave sideward-extending whiskers 102. Preferably, each of the outer blades 22 and 24 is meshed and has a generally trapezoidal cross-sectional. The long side of the trapezoidal cross-section serves as an outer side that comes into contact with the skin 111.

As schematically shown in FIG. 5C, the middle outer blade 23 and the middle inner blade 33 (not shown in FIG. 5C) are mainly used to shave fine and long whiskers 103. Preferably, the outer blade 23 includes a slit extending in the frontward and rearward directions and has a cross-sectional that is thick in the upward and downward directions.

As shown in FIGS. 2, 3A, and 6, the electric shaver 11 of the present invention includes a trimmer unit 71, which is used to trim body hair, for example, sideburns and the hair at the back of the head.

As shown in FIGS. 2 and 6, the trimmer unit 71 includes a trimmer case 72, a trimmer fixed blade 73, and a trimmer drive blade 74. The trimmer fixed blade 73 is fixed to the trimmer case 72. The trimmer drive blade 74 is held by the trimmer case 72 so as to be slidable relative to the trimmer fixed blade 73. Further, the trimmer unit 71 includes a lever coupling member 75 and a trimmer cover 76. The lever coupling member 75 is pivotally supported by a support shaft 72a, which is formed on the trimmer case 72. The trimmer fixed blade 73, the trimmer drive blade 74, and the lever coupling member 75 are arranged between the trimmer case 72 and the trimmer cover 76. The lever coupling member 75 includes a support hole 75a, an input projection 75b, and an output projection 75c. The support hole 75a is fitted to the support shaft 72a. The input projection 75b and output projection 75c are arranged at positions spaced apart by 180° in the circumferential direction about the support hole 75a. The output projection 75c is inserted into an engagement hole 74a, which is formed in the trimmer drive blade 74. Accordingly, when external force is applied to a circumferential side surface of the input projection 75b, the trimmer drive blade 74 is driven and slid relative to the trimmer fixed blade 73.

The user may perform an operation that couples the input projection 75b, that is, the trimmer drive blade 74 with the first drive element 51.

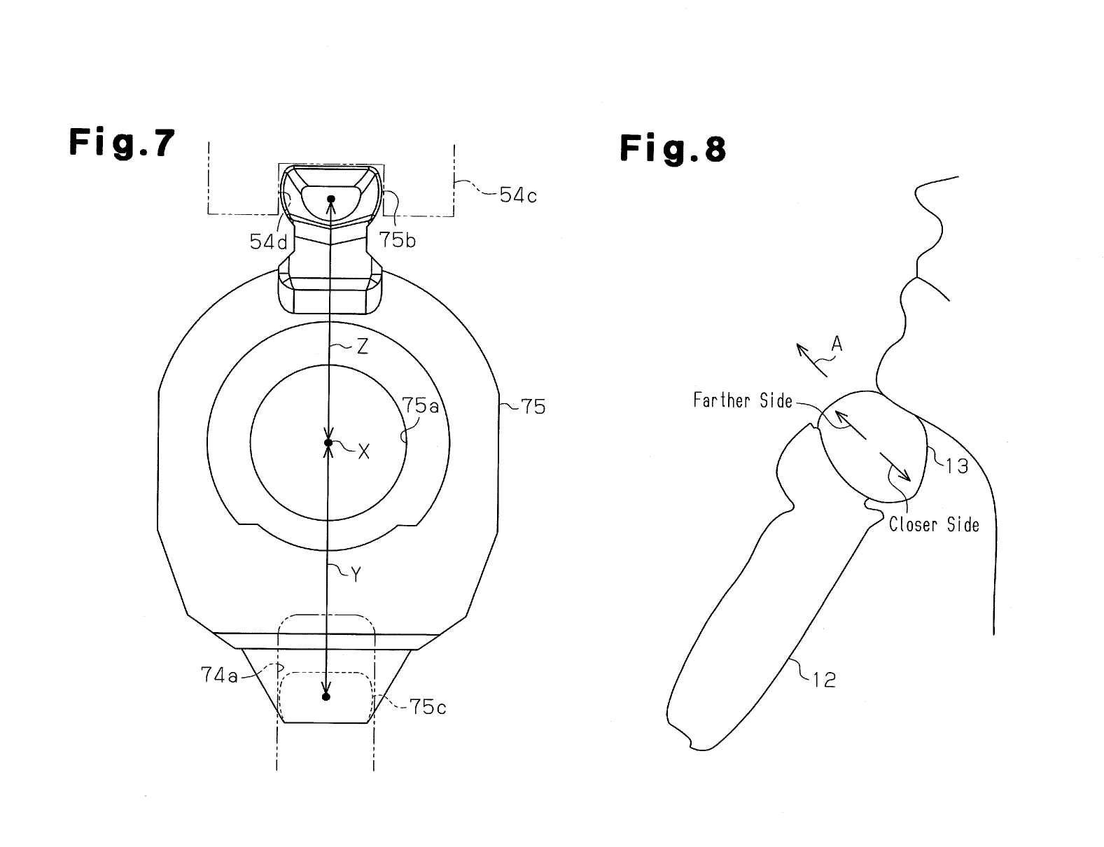

As shown in FIGS. 2 to 4, a trimmer drive piece 54c is formed integrally with the fastening portion 54a of the first drive piece 54, which is fixed to the first drive element 51. The trimmer drive piece 54c extends rearward from the pin 54b of the first drive piece 54. Referring to FIG. 7, the trimmer drive piece 54c includes a distal end that defines a coupling portion 54d, which has two opposing surfaces that can be coupled to the input projection 75b of the lever coupling member 75. When the trimmer unit 71 is located at the position shown in FIG. 2, the input projection 75b is not coupled to the coupling portion 54d. The trimmer unit 71 is pivotal in the direction indicated by arrow B in FIG. 2 relative to the head case 61 about a position slightly separated from the coupling portion 54d. When the user operates and pivots the trimmer unit 71, referring to FIG. 7, the input projection 75b is inserted between the opposing surfaces of the coupling portion 54d, and thus, the lever coupling member 75 is coupled to and driven by the first drive piece 54. In this state, when the first drive element 51 is driven back and forth in the widthwise direction, the coupling portion 54d of the trimmer drive piece 54c formed in the first drive piece 54 is driven back and forth in the widthwise direction. This pivots the lever coupling member 75 via the input projection 75b and drives the trimmer drive blade 74 back and forth in the widthwise direction with the output projection 75c.

In the present embodiment, the dimensions of the lever coupling member 75 is set so that the amplitude of the trimmer drive blade 74 is greater than the amplitude of the coupling portion 54d of the trimmer drive piece 54c. As shown in FIG. 7, for example, distance Y from the pivot center X of the lever coupling member 75 to the output projection 75c is greater than distance Z from the pivot center X to the input projection 75b. In the present embodiment, distance Y is 1.07 times greater than distance Z. That is, the lever ratio of the lever coupling member 75 is 1 to 1.07.

The operation of the electric shaver 11 will now be described.

When supplied with drive current from the rechargeable battery, the linear motor 41 drives and moves the first and second drive elements 51 and 52 back and forth in the widthwise direction but in different directions to each other (opposite phases). This results in moving the two inner blades 31 and 32, which are coupled to the first drive element 51, and the three inner blades 33 to 35, which are coupled to the second drive element 52, back and forth in the widthwise direction but in difference directions to each other (opposite phases). The inner blades 31 to 35 cooperate with the outer blades 21 to 25 to shave body hair (whiskers) that has been guided to the inner side of the outer blades 21 to 25. In the present embodiment, the amplitude of the reciprocation of the first drive element 51 is set to be greater than the amplitude of the reciprocation of the second drive element 52.

In a state in which the user operates and pivots the trimmer unit 71, when the two inner blades 31 and 32, which are coupled to the first drive element 51, are driven back and forth, the trimmer drive blade 74 is driven back and forth. In this state, the tips of the trimmer fixed blade 73 and trimmer drive blade 74 are held near body hair (e.g., sideburns and the hair at the back of the head) to clip and cut the body hair.

The present embodiment has the advantages described below.

(1) The inner blades 31 to 35 are coupled to the first drive element 51 and the second drive element 52 at a ratio of two to three. Thus, in comparison with the three-blade shaver of the prior art in which the ratio of the blades is one to two, the ratio of the weight acting on the first drive element 51 and second drive element 52 is close to one to one. Further, this structure allows the first drive element 51 to be set with a greater amplitude than the second drive element 52 and sufficiently reduces vibration.

The first and second drive elements 51 and 52 are driven at different amplitudes. Thus, the electric shaver 11 of the present embodiment may use a function that utilizes different amplitudes (rough and finish shaving function) while sufficiently reducing vibration, whereas in the prior art, it was difficult for a four-blade shaver having a two to two ratio to have such a function. In a three-blade or four-blade shaver, a balancing weight may be used to obtain the same weight ratio as the present embodiment. In contrast, the present embodiment adds weight by increasing the number of blades. This adjusts the weight balance and improves the shaving performance. Accordingly, the electric shaver 11 of the present embodiment is more advantageous than when just adding a weight.

(2) The first drive element 51, which is coupled to the two inner blades 31 and 32, is arranged at the rear side, which is the side of the electric shaver 11 farther from the user when held in a normal manner. The second drive element 52, which is coupled to the three inner blades 33 to 35, is arranged at the front side, which is closer to the user. In this case, the amplitude of the first drive element 51 may be set to be greater than the amplitude of the second drive element 52 like in the present embodiment. This reduces vibration. Further, during normal use, the rear inner blades 31 and 32 having the larger amplitude (and outer blades 21 and 22) may first roughly shave whiskers. Then, the remaining whiskers may undergo finish shaving with the front inner blades 33 to 35 having the smaller amplitude (and outer blades 23 to 25). This may shorten the shaving time. In a state of normal use, the electric shaver 11 is moved against the direction in which whiskers grow. That is, the electric shaver 11 is moved in the direction from the neck toward the nose and ears as shown by arrow A in FIG. 8.

(3) The three inner blades 33 to 35 coupled to the second drive element 52 and the three outer blades 23 to 25 are used to shave the whiskers 101 to 103, which are in different states. This allows for a clean and efficient shave.

(4) The first and second drive pieces 54 and 55, which are coupled to the inner blades 31 and 35 located at the outermost positions in the frontward and rearward directions, are respectively fixed to the first and second drive elements 51 and 52. The first and second drive pieces 54 and 55 include the resin fastening portions 54a and 55a, which are fixed to the first and second drive elements 51 and 52, and the metal pins 54b and 55b, which are fixed to the fastening portions 54a and 55a and coupled to the outermost inner blades 31 and 35, respectively. This supports the outermost inner blades 31 and 35 with the metal pins 54b and 55b. Thus, the inner blades 31 and 35 are supported more rigidly than when supported by resin components. During normal use, the outermost inner blades 31 and 35 are the first and last blades that are locally pressed against the skin. Thus, the inner blades 31 and 35 are required to have a long life and a high cutting capability. In this respect, the inner blades 31 and 35 are rigidly coupled and supported by the metal pins 54b and 55b and thereby have a long life and high cutting capability.

(5) The middle drive piece 56, which is coupled to the middle inner blade 33 located at the middle position in the frontward and rearward directions, is fixed to the second drive element 52. The middle drive piece 56 includes the resin fastening portion 56a, which is fixed to the second drive element 52, and the resin support 56b, which is formed integrally with the fastening portion 56a and coupled to the middle inner blade 33. During normal use, the middle inner blade 33 is neither the first nor last blade locally pressed against the skin. Thus, the middle inner blade 33 is not required to have a long life or high cutting capability. Therefore, the middle inner blade 33 is supported by the resin support 56b. This allows for reduction in the cost of the middle drive piece 56. Further, in comparison with when using, for example, a metal pin, the weight acting on second drive element 52 may easily be decreased and the drive efficiency may be increased. Further, the second drive element 52 is arranged between the middle drive piece 56 (support 56b) and the second drive piece 55 (pin 55b). Thus, the distance from the second drive element 52 to the middle drive piece 56 (support 56b) and the distance from the second drive element 52 to the second drive piece 55 (pin 55b) may both be shortened. This prevents flexing and twisting that would occur when such distances are long.

(6) The outermost inner blade 35, which is coupled to the second drive element 52 by the second drive piece 55, is held in the frame portion 25a of the outer blade 25 so as to be movable in the widthwise direction. The inner blade 35 includes the coupling hole 35a, which is fitted and coupled to the metal pin 55b. The middle inner blade 33, which is coupled to the second drive element 52 by the middle drive piece 56, is held between the frame portions 22a and 24a, which are immovable in the frontward and rearward directions relative to the outer blade 23, to be movable in the widthwise direction. The inner blade 33 includes the coupling groove 33a, which is fitted to and coupled to the resin support 56b. The coupling groove 33a is shaped to couple the support 56b to be immovable relative to the inner blade 33 in the widthwise direction while permitting slight movement of the support 56b in the frontward and rearward directions. In the present embodiment, the coupling groove 33a is an opening having dimensions that are slightly greater than the support 56b in the frontward and rearward directions. Thus, the pin 55b and the support 56b are respectively coupled to the outermost inner blade 35 and middle inner blade 33 in a satisfactory manner. When the coupling groove 33a does not allow movement of the support 56b in the frontward and rearward directions and the positional accuracy in the frontward and rearward direction is poor, the coupling may be unsatisfactory and the inner and outer blades may be strongly pressed against each other. The present embodiment avoids such a situation.

(7) The fastening portion 54a, which includes the drive piece 54c, is fixed to the first drive element 51, which is coupled to the two inner blades 31 and 32. The user performs an operation when necessary to couple the trimmer drive blade 74 to the trimmer drive piece 54c. In comparison with when the trimmer drive piece 54c is fixed to the second drive element 52, the weight acting on the first and second drive elements 51 and 52 is balanced in a preferable manner, and vibration is reduced when the trimmer drive blade 74 is driven.

(8) The trimmer drive piece 54c is formed integrally with the fastening portion 54a of the first drive piece 54, which is fixed to the first drive element 51 and coupled to the outermost inner blade 31. Thus, in comparison to when the trimmer drive piece 54c is formed as a discrete element, the number of components and assembly steps are reduced, which reduces costs.

(9) The lever coupling member 75 couples the trimmer drive piece 54c and the trimmer drive blade 74. The dimensions of the lever coupling member 75 are set so that the amplitude of the trimmer drive blade 74 is greater than the amplitude of the coupling portion 54d of the trimmer drive piece 54c. This structure compensates for amplitude loss resulting from twisting and flexing between the first drive element 51 and the coupling portion 54d and allows the trimmer drive blade 74 to be driven at the optimal amplitude. When the trimmer drive blade 74 is arranged rearward from the outermost inner blade 31, the amplitude of the coupling portion 54d tends to become small due to twisting and flexing between the first drive element 51 and the coupling portion 54d. However, the structure of the present embodiment compensates for the decreased amplitude and drive the trimmer drive blade 74 with the optimal amplitude.

It should be apparent to those skilled in the art that the present invention may be embodied in many other specific forms without departing from the spirit or scope of the invention. Particularly, it should be understood that the present invention may be embodied in the following forms.

In the above embodiment, the first drive element 51, which is coupled to the two inner blades 31 and 32, is arranged at the rear, and the second drive element 52, which is coupled to the three inner blades 33 to 35, is arranged at the front. However, the present invention is not limited to such a structure, and this arrangement may be reversed.

The amplitude of the first drive element 51 does not have to be greater than the amplitude of the second drive element 52 like in the above embodiment. In the above embodiment, the inner blades 31 to 35 are coupled to the first drive element 51 and the second drive element 52 at a ratio of two to three. In contrast with the three-blade shaver of the prior art in which the ratio is one to two, the weight ratio acting on the first drive element 51 and the second drive element 52 becomes close to one to one. This reduces vibration in comparison to the three-blade shaver of the prior art.

In the above embodiment, the inner blades 33 to 35, which are coupled to the second drive element 52, and outer blades 23 to 25 function to shave the whiskers 101 to 103, which are in different states. However, the present invention is not limited in such a manner. As long as the three inner blades coupled to the second drive element 52 or the three corresponding outer blades all have different functions or shapes, the present invention is not limited to the structure of the above embodiment. For example, among the three inner blades, a first and second inner blade may have the same shape, the third inner blade may have a different shape, the second and third outer blades corresponding to the second and third inner blades may have the same shape, and the first outer blade corresponding to the first inner blade may have a different shape. In this case, the relationship of the inner blades and the outer blades achieves different functions. This obtains a clean and efficient shave. However, in the present invention, the three inner blades coupled to the second drive element 52 and the three corresponding three outer blades are not necessarily required to all have different functions or shapes.

The structure of the first and second drive pieces 54 and 55 in the above embodiment may be changed. For example, the pins 54b and 55b may be formed integrally with the resin fastening portions 54a and 55a.

The structure of the middle drive piece 56 in the above embodiment may be changed. For example, the resin coupling portion 56b may be changed to a metal pin fixed to the resin fastening portion 56a.

The structure (shape) of the coupling groove 33a (resin coupling portion) in the above embodiment may be changed. For example, the resin coupling portion 56b and support 56 may have the same dimensions in the frontward and rearward directions to not allow movement of the support 56b in the frontward and rearward directions.

In the above embodiment, the electric shaver 11 includes the trimmer unit 71. However, the present invention is not limited in such a manner, and the trimmer unit 71 may be eliminated from the electric shaver 11.

In the above embodiment, the fastening portion 54a, which includes the trimmer drive piece 54c, is fixed to the first drive element 51, which is coupled to the two inner blades 31 and 32. However, the present invention is not limited to such a structure, and the trimmer drive piece 54c may be fixed to the second drive element 52.

In the above embodiment, the trimmer drive piece 54c is formed integrally with the fastening portion 54a of the first drive piece 54. However, the present invention is not limited to such a structure, and the trimmer drive piece 54c may be discrete from the fastening portion 54a.

In the above embodiment, the dimensions of the lever coupling member 75 are set so that the amplitude of the trimmer drive blade 74 is greater than the amplitude of the coupling portion 54d of the trimmer drive piece 54c. However, the present invention is not limited in such a manner, and the amplitude of the trimmer drive blade 74 does not have to be greater than the amplitude of the coupling portion 54d.

The present examples and embodiments are to be considered as illustrative and not restrictive, and the invention is not to be limited to the details given herein, but may be modified within the scope and equivalence of the appended claims.

1. An electric shaver comprising:
a head;
a plurality of outer blades located next to one another in an arrangement that extends in frontward and rearward directions of the head;
a drive source that drives a first drive element and a second drive element back and forth in different directions to each other; and
a plurality of inner blades each coupled to and driven by the first drive element or the second drive element to be movable back and forth in a longitudinal direction of the outer blades, which is a widthwise direction of the head, at an inner side of the outer blades,
wherein the inner blades are coupled to the first drive element and the second drive element at a ratio of two to three.

2. The electric shaver according to claim 1, wherein:
the first drive element is arranged at a rear side of the head in the frontward and rearward directions and coupled to two of the inner blades; and
the second drive element is arranged at a front side of the head in the frontward and rearward directions and coupled to the other three of the inner blades.

3. The electric shaver according to claim 2, wherein the three inner blades coupled to the second drive element or three ones of the outer blades corresponding to the three inner blades all have a different function or shape.

4. The electric shaver according to claim 1, further comprising first and second drive pieces respectively fixed to the first and second drive elements and respectively coupled to first and second ones of the plurality of inner blades that are located at outermost positions in the frontward and rearward directions, wherein
the first drive piece includes a first resin fastening portion, which is fixed to the first drive element, and a first metal pin, which is fixed to the first resin fastening portion and coupled to the first inner blade, and
the second drive piece includes a second resin fastening portion, which is fixed to the second drive element, and a second metal pin, which is fixed to the second resin fastening portion and coupled to the second inner blade.

5. The electric shaver according to claim 4, further comprising a middle drive piece fixed to the second drive element and coupled to a third one of the inner blades that is located at a middle position in the frontward and rearward directions, wherein
the middle drive piece includes a third resin fastening portion, which is fixed to the second drive element, and a resin support, which is formed integrally with the third resin fastening portion and coupled to the third inner blade.

6. The electric shaver according to claim 5, further comprising a plurality of frame portions that are immovable in the frontward and rearward directions and hold the plurality of inner blades to be movable in the widthwise direction, wherein
the second inner blade includes a pin coupling portion coupled to the second metal pin,
the third inner blade includes a resin coupling portion coupled to the resin support, and
the resin coupling portion is shaped to prohibit movement of the resin support relative to the third inner blade in the widthwise direction while permitting slight movement of the resin support in the frontward and rearward directions.

7. The electric shaver according to claim 1, wherein two of the plurality of inner blades are coupled to the first drive element, and the electric shaver further comprises:
a trimmer drive piece fixed to the first drive element; and
a trimmer drive blade configured to be coupled to and driven by the trimmer drive piece.

8. The electric shaver according to claim 7, further comprising a first drive piece fixed to the first drive element, wherein
the first drive piece includes a first resin fastening portion coupled to one of the two inner blades coupled to the first drive element, and
the trimmer drive piece is formed integrally with the first resin fastening portion.

9. The electric shaver according to claim 7, further comprising a lever coupling member that couples the trimmer drive piece and the trimmer drive blade, wherein
the trimmer drive piece includes a coupling portion coupled to part of the lever coupling member to drive and move the trimmer drive blade back and forth when the first drive element moves back and forth, and
the lever coupling member has dimensions set so that amplitude of the trimmer drive blade is greater than amplitude of the coupling portion of the trimmer drive piece.
